(19) United States
(12) Patent Application Publication
(10) Pub. No.: US 2003/0115084 A1
(43) Pub. Date: Jun. 19, 2003

(54) System and method for electronic medical record keeping

(75) Inventor: John S. Gage, Stony Brook, NY (US)

Correspondence Address: Frank Chau, F. CHAU & ASSOCIATES, LLP, Suite 501, 1900 Hempstead Turnpike, East Meadow, NY, 11554, US

(73) Assignee: Research Foundation of State University of New York

(21) Appl. No.: 10/026,138

(22) Filed: Dec. 19, 2001

(51) Int. Cl. G06F 17/60

(52) U.S. Cl. 705/3; 705/2

(57) ABSTRACT

A portable medical record comprises a plurality of processors connected by a network to database including a medical record, a plurality of folders for storing messages in the medical record, a means for controlling access to each of the folders, and a means for sorting each messages into at least one folder.

### BACKGROUND OF THE INVENTION

1. Field of the Invention

The present invention relates to a system and method for storage, retrieval and communication of medical records.

2. Discussion of Related Art

Medical records traditionally serve dual, nearly dichotomous purposes: a medical record is used for communication among health care providers and, orthogonally, as an audit tool by payors, regulators, etc. Against this traditional backdrop, a new trend has emerged: patients, under the Health Insurance Portability and Accountability Act of 1996:HIPAA, for example, now have access to, may control access to, and can amend their medical records. Thus, at least one version of the medical record must fulfill its communication task, in plain language, not just with health care providers but also with the patient.

Communication using the medical record is fundamental to good patient care. For example, a physician, nurse or other provider writes a note in a patient's record to notify and inform his/her colleagues of any changes, new thinking, or information about a patient's condition or treatment. These notes plus laboratory reports, consultation reports, medication orders, appointments, etc., can be entered as they become available. Thus, a medical record includes the most up to date information to aid a care team, in the form of a temporal series of provider notes, lab reports, etc., but like all temporal information, their value can deteriorate over time. This deterioration is apparent in the way the traditional record is organized and used. Experienced physicians leafing through the patient's record go from back to front, examining the most recent information first. Charts that grow too large can be “split”, leaving old information behind. Thus, in a given patient's record, only a variable percentage of the contents may be of current clinical value. For example, the patient's order for Colace ten days ago may be of modest relevance to the patient's current care, and the patient's appointment at 2:30 PM on Jan. 15, 1995 for orthopedics is no longer relevant at all. The medical record functions clinically as a communication system between providers: a series of notes, reports, studies about the patient, whose pertinence and value can deteriorate over time.

Traditional, hand-written, paper medical records perform many of these clinical communication tasks quite well. The information they include is distributed and organized in an orderly fashion, easily accessible by an experienced provider. Thus, it is the traditional record's ability to support communication between and among providers, competently and reasonably efficiently, which has permitted the traditional record to survive and continue to support excellence in clinical practice.

In contrast to its clinical role, the medical record can also be used for audit, a task that may be considered orthogonal to clinical communication. Audit includes, inter alia, billing, quality assurance, teaching, research, litigation, and regulatory agency review: anything that is not directly related to immediate patient care and that can occur asynchronously or orthogonally with patient care. In this area of supporting audit, the traditional, paper record can perform poorly. Most audit tasks are carried out by non-physicians and non-medical personnel who may lack the familiarity and expertise of the provider or the provider's assistants to sort through the traditional record.

But auditing patient care is not the same as delivering it. Thus, the traditional record is an excellent, low-tech solution that permits care to be delivered, but which cannot support an increasingly active and important audit task imposed on medicine by legislative regulations (such as HIPPA), Health Maintenance Organizations, or other payors or governmental agencies.

To remedy the traditional record's limited value as an audit instrument, information technologists have attempted to create an electronic medical record taking advantage of the power of information technology to store and retrieve data. Electronic records in medical application have several problems, however. For example, when information technologists attempt to create a unified electronic medical record, they immediately confront a bewildering installed base of incompatible computer systems controlling everything from laboratory results to the master patient index. This situation is commonly referred to as “Best of Breed”: individual departments selecting a commercial computerized system available to perform their local functionality without regard to the chosen system's ability to integrate with other systems already in place or planned for their institution. The result of Best of Breed is that machine-to-machine communication between incompatible systems quickly becomes an important task in creating an electronic medical record. Instead of focusing on communication between providers, creators of an electronic record focus on machines. Communication between providers becomes a wished-for side effect of the immediate and overwhelming task of getting incompatible electronic data systems to integrate with each other.

One proposed system for providing machine-to-machine communication in a Best of Breed environment is the Health Level 7 (HL7) interface language. Unfortunately, HL7 version 2.x is a synchronous, technologically backward, low bandwidth, largely arbitrary encoding scheme, unintelligible to healthcare providers and lacking even rudimentary security capability. Integration tasks between computer systems, using HL-7 can be extremely difficult, and in addition, as the number of different computer systems in an institution increases the number of HL7 interfaces needed to support them grows.

Beyond the local difficulties imposed by Best of Breed, designers and implementers of medical software need to confront a larger integration problem outside any given institution, over which they have even less control. Medical care organizations and other payors can dictate the patient's choice of laboratories, pharmacies, etc. The result is that laboratory reports for outpatients may come from a plethora of rapidly changing loci outside an institution, all of which have computer systems that may not be easily connected or integrated with the institution's electronic record. Also, patients may fill and refill prescriptions at several different remote pharmacies that use different computer systems.

Finally, medical software designers need now satisfy the new HIPAA regulations that specify, for example, a) patient access to their medical records, b) patient consent to the distribution of their medical data, c) patient restrictions on the distribution of their medical data (“negative” consent), d) patient education about their privacy rights under these regulations, and e) the ability of the patient to amend their medical record. No current system or method provides for these patient communication tasks in a comprehensive fashion as an integrated part of the medical record.

Standards in medical computing per se that might alleviate this situation do not exist. Instead, there are hosts of sometimes competing, sometimes proprietary terminology standards, nearly all of which are used in the billing process and none of which are facilely adopted by human users of natural language. HL7 remains the standard in medical computing for communication, but provides only limited, limiting, and completely insecure communication between incompatible hardware and software.

Therefore, a need exists for a standard electronic information infrastructure in medicine.

### SUMMARY OF THE INVENTION

According to an embodiment of the present invention, a method is provided for making an entry to an electronic medical record. The method comprises associating the medical record with a patient, wherein the medical record is managed by an administrator, providing access to a portion of the medical record, receiving an entry at a server serving the medical record on a network of processors, wherein the medical record includes at least one folder storing the entry, and storing the entry in a folder according to a header of the entry. The entry is provided by a user, the user is one of a patient and a provider. The entry is provided by a user, the user is one of a business and an organization. The entry is provided by a processor on the network.

Providing access further comprises providing patient consent.

The method comprises providing limited access and usage to a user according to a user's current identity. The method provides limited access and usage to a user according to a user's scope of employment. The method comprises providing limited access and usage to a user according to a user's demographic profile. The method comprises providing limited access and usage to a user according to a user's business character. The method further comprises providing limited access and usage to a user according to a user's group membership. The method provides limited access and usage to a user according to a user's security clearance.

The entry received at the server is encrypted by a sender. The entry received at the server is digitally signed.

According to an embodiment of the present invention, a program storage device is provided readable by machine, tangibly embodying a program of instructions executable by the machine to perform method steps for making an entry to an electronic medical record. The method comprises associating the medical record with a patient, wherein the medical record is managed by an administrator, providing access to a portion of the medical record, receiving an entry at a server serving the medical record on a network of processors, wherein the medical record includes at least one folder storing the entry, and storing the entry in a folder according to a header of the entry.

According to an embodiment of the present invention, a system is provided for a portable medical record. The system comprises a plurality of processors connected by a network to database including a medical record, a plurality of folders for storing messages in the medical record, a means for controlling access to each of the folders, and a means for sorting each messages into at least one folder.

The message can be one of a plain text message, a digital image, an audio file, and a multimedia file. The message includes one or more attachments. A message attachment can be one of plain text message, a digital image, an audio file, and a multimedia file.

The means for controlling access further comprises a data encryption module for encryption communications across the network, and a digital signature module.

According to yet another embodiment of the present invention, a graphical User interface system is provided supporting a medical record comprising a menu generator for generating: at least one menu permitting User browsing of at least one folder of a medical record, and a menu permitting User entries to the medical record, wherein each entry is automatically filed into at least one desired folder of the medical record.

The graphical User interface further comprises a means for accessing a multimedia file including a portion of an entry to the medical record. The multimedia file is comprised of multipurpose Internet mail extensions.

### BRIEF DESCRIPTION OF THE DRAWINGS

Preferred embodiments of the present invention will be described below in more detail, with reference to the accompanying drawings:

FIG. 1 is an illustration of a collection of folders in a medical record according to an embodiment of the present invention;

FIG. 2 is a diagram of a system including a medical record according to an embodiment of the present invention;

FIG. 3 is a flow chart of a method for forming a medical record according to an embodiment of the present invention; and

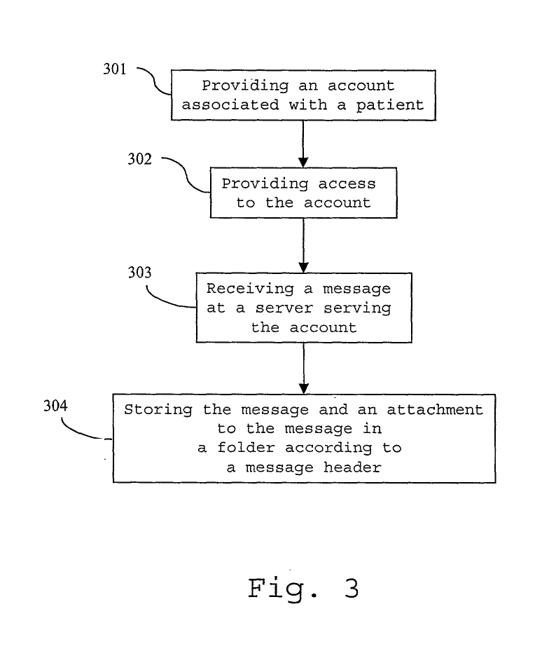

FIG. 4 is a user interface to a medical record keeping application according to an embodiment of the present invention.

### DETAILED DESCRIPTION OF PREFERRED EMBODIMENTS

The present invention provides a system and method for medical record keeping. A medical record can include data related to, for example, scheduling, billing, and other medically related computer applications. The medical record can be shared across a range of hardware and software, and between a plurality of users. For example, as between a physician and a nurse, a physician and a pharmacist, a physician and an administrator, a physician and a patient, or an administrator and a patient.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components, or the method steps, may differ depending upon the manner in which the present invention is programmed. Given the teachings of the present invention provided herein, one of ordinary skill in the related art will be able to contemplate these and similar implementations or configurations of the present invention.

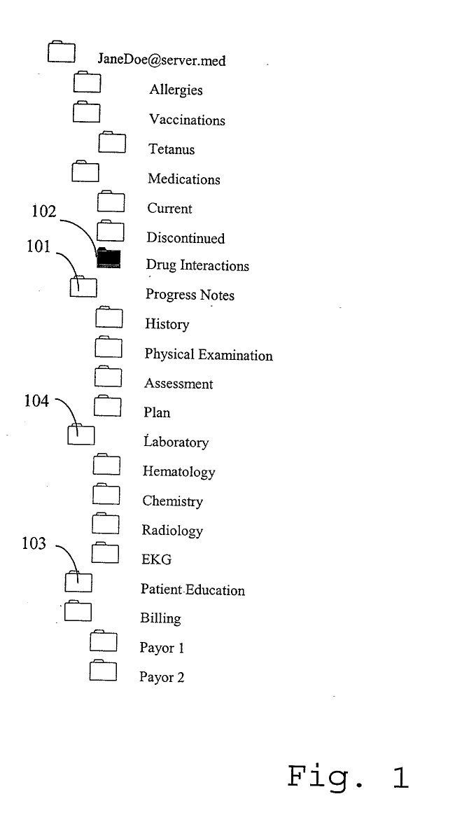

According to an embodiment of the present invention, a user interface is provided for accessing a medical record. The interface can include links to a plurality of medical records. Each medical record is associated with a patient. Referring to FIG. 1, each medical record includes one or more folders, e.g., 101. Incoming entries to the record can be automatically sorted into these folders. These entries, for example, text messages, can accumulate, as they are received, in chronological order, in one or more folders. The messages can be separated into groups automatically according to a number of topics. Automatic sorting can be accomplished using, for example, address extensions in each entry to the record. Folders including unread messages, e.g., 102, for example, including time critical information, can be automatically identified through various attributes such as a different color, a flag, or other identifying means. Messages can have multiple attachments each containing essentially the same information in different formats (language, purpose, etc.) each attachment being sorted into a different folder corresponding to its content.

A given medical record, according to the present invention, is distinguished from an account of a patient whose medical record is being collected. The patient may direct the control of access to the medical record but the record is under the on-going supervision of, for example, a central medical records administrator.

The medical record is an account used to collect messages including medical information about the patient. A provider can look up the medical record using for example, an Lightweight Directory Access Protocol (LDAP) server, who the provider has access rights to.

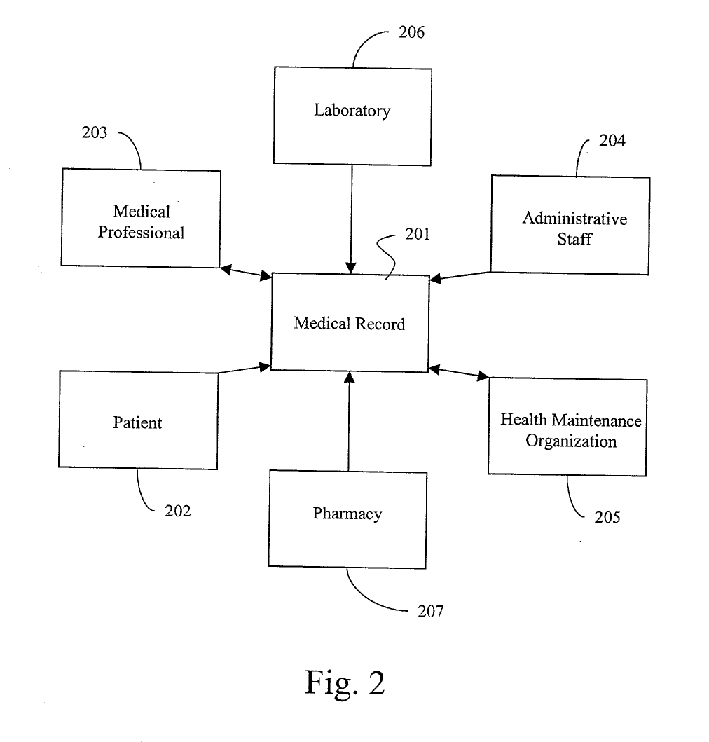

Referring to FIG. 2, the medical record 201 collects information from medical 203 and administrative staff 204. Under defined circumstances, a patient 202 may have access to the medical record, for example, to provide an entry directed to a caregiver, receive instructions from a caregiver, review the record, emend certain portions of the record, or restrict access to it. Many health care providers, governed by a centrally administered access control system, can have access to various folders within the medical record. For example, health maintenance organizations (HMOs) 205, laboratories 206 and pharmacies 207 may all be given access to the medical record. It should be noted that the various medical record clients, 202-207, can be embodied by, for example, a personal computer that communicates with the medical record. For example, a laboratory computer can send lab results to the medical record 201 autonomously. Access can be controlled with well-defined security procedures. Messages to the medical record cannot be deleted, just as entries in the paper record are not deleted. However, there may be instances where an entry is deleted or amended, for example, after a given time, or at the direction of a physician or the patient. Additions to the medical record are enumerated. Thus, an electronic medical record can provide a means for communicating between providers based on standardized software.

According to an embodiment of the present invention, different members of the health care community may be given different privileges within the scope of the medical record. For example, as shown in FIG. 2, a medical professional 203 can read from and write to all folders within the medical record 201, while the patient 202 and administrative staff 204 cannot read from all folders of the medical record 201 but can write to select folders within the medical record 201. For example, administration staff 204 may have access to billing 103 in FIG. 1, but not to progress notes 104 in FIG. 1.

According to an embodiment of the present invention, the medical record can be accessed over a TCP/IP interface network protocol. Thus, the present invention can be run on existing systems and architectures to communicate between computers.

Messages including medical data can be sent in plain text. In addition, messages can include attached files. Attached files can include, for example, plain text, HTML formatted text, digital images, such as an X-ray or magnetic resonance image (MRI). The message can include sound files, such as a .wav file, for example, a recording of heart or breath sounds. Attachments may contain essentially the same information as other attachments formatted for varying purposes.

The system supports intra- and extra-institutional communication between computer systems. It is geographically neutral and can take advantage of the ubiquitous Internet for transmission.

Proposed networking standards for securing messages over the TCP/IP network can be applied to the system and method of medical record keeping. For example, the present invention can employ mail transfer agents such as Sendmail or Exim, hosted on a machine sending and/or receiving messages. The elements of the message can be encoded and/or digitally signed before the message goes out over the network. Accordingly, an intercepted message can be protected from security threats. In addition, messages and access to the medical record can be logged. The logged message can satisfy the Health Insurance Portability and Accountability Act of 1996 (HIPAA). Another example of a rule under HIPPA, which can be implemented using message attachments over the present invention, is Electronic Data Interchange, setting standards for electronic healthcare transactions.

The present invention includes a means for automatically displaying summary data taken from multiple messages. Message headers indicate the folder or folders in which to place the message and its attachments, and may indicate that the message or attachment can be automatically forwarded and added to a database. Upon receipt of the message, the database can add the message to a desired table, for example, in a relational system, and formulate a new message containing an arbitrary number of records given in a configuration file to be sent back to a different, summary folder in the medical record. Therefore, the medical record can include both individual data points and summary data. Accordingly, the medical record can send and receive messages.

MIME encoding of messages can aid in the viewing of the medical records. For example, a caregiver can select a pre-existing application for viewing a message or messages or summary within the medical record. Similarly, the medical record can be implemented under the IMAP standards. One of ordinary skill in the art would appreciate that standards can change over time and that the present invention can be implemented independently of any particular standard.

A method, according to an embodiment of the present invention, includes providing an account associated with a patient, wherein the account is managed by an administrator 301 who may be the patient, and providing access to the account, wherein initial access may be controlled by the patient 302. The method further includes receiving a message, which can include an attachment, generated by a user, at a server serving the medical record, wherein the medical record includes more or less folders 303, and storing the message and the attachment in a folder or folders according to the message header or headers 304.

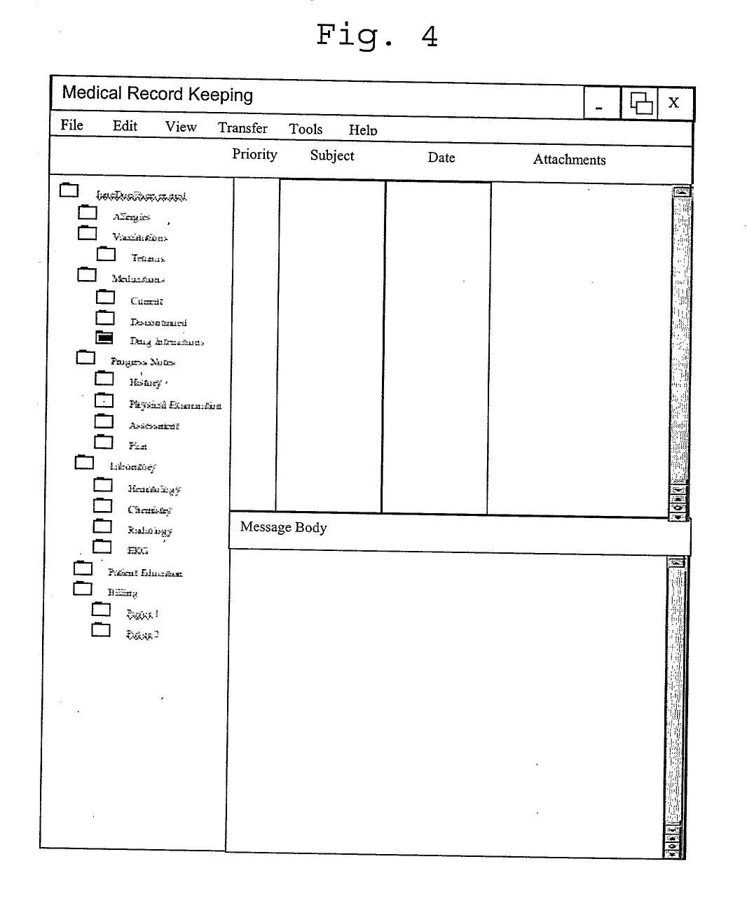

Referring to FIG. 4, the present invention provides a user interface including, inter alia, functionality related to managing the medical record, for example, cutting and pasting or copying entries or by using graphical icons, selection boxes or pull-down menus. The user interface can enable a user to view multiple folders simultaneously. Dialog boxes and/or windows can be provided for displaying various information, for example, for displaying a graph.

Further, according to an embodiment of the present invention, the following characteristics can be provided for: a) Patients are provided access to their medical records. The patient can obtain a copy of their own health records in the form of, for example, a paper printout or electronic record. b) Patient consent can be a prerequisite to the distribution of their medical data. Additionally, a patient can determine how their information may be used and what disclosures have been made. Disclosure information can be cataloged and/or can be determined from a review of previously sent records. c) Patients can place restrictions on the distribution of their medical data (“negative” consent). Therefore, the patient can become involved in the access control process. d) Patients can be educated about their privacy rights under applicable regulations. e) The patient can emend their medical record. These and other characteristics are provided for according to an embodiment of the present invention.

Having described embodiments for system and method providing a standard interface between users in a health care environment capable of providing communication and audit functionality, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for making an entry to an electronic medical record comprising the steps of:
associating the medical record with a patient, wherein the medical record is managed by an administrator;
providing access to a portion of the medical record;
receiving an entry at a server serving the medical record on a network of processors, wherein the medical record includes at least one folder storing the entry; and
storing the entry in a folder according to a header of the entry.

2. The method of claim 1, wherein the entry is provided by a user, wherein the user is one of a patient and a provider.

3. The method of claim 1, wherein the entry is provided by a user, wherein the user is one of a business and an organization.

4. The method of claim 1, wherein the entry is provided by a processor on the network.

5. The method of claim 1, wherein the step of providing access further comprises the step of providing patient consent.

6. The method of claim 1, further comprising the step of providing limited access and usage to a user according to a user's current identity.

7. The method of claim 1, further comprising the step of providing limited access and usage to a user according to a user's scope of employment.

8. The method of claim 1, further comprising the step of providing limited access and usage to a user according to a user's demographic profile.

9. The method of claim 1, further comprising the step of providing limited access and usage to a user according to a user's business character.

10. The method of claim 1, further comprising the step of providing limited access and usage to a user according to a user's group membership.

11. The method of claim 1, further comprising the step of providing limited access and usage to a user according to a user's security clearance.

12. The method of claim 1, wherein the entry received at the server is encrypted by a sender.

13. The method of claim 1, wherein the entry received at the server is digitally signed.

14. A program storage device readable by machine, tangibly embodying a program of instructions executable by the machine to perform method steps for making an entry to an electronic medical record, the method steps comprising:
associating the medical record with a patient, wherein the medical record is managed by an administrator;
providing access to a portion of the medical record;
receiving an entry at a server serving the medical record on a network of processors, wherein the medical record includes at least one folder storing the entry; and
storing the entry in a folder according to a header of the entry.

15. A system for a portable medical record comprising:
a plurality of processors connected by a network to database including a medical record;
a plurality of folders for storing a message in the medical record;
a means for controlling access to each of the folders; and
a means for sorting the message into at least one folder.

16. The system of claim 15, wherein the message can be one of a plain text message, a digital image, an audio file, and a multimedia file.

17. The system of claim 15, wherein the message includes one or more attachments.

18. The system of claim 17, wherein a message attachment can be one of plain text message, a digital image, an audio file, and a multimedia file.

19. The system of claim 15, wherein the means for controlling access further comprising:
a data encryption module for encryption communications across the network; and
a digital signature module.

20. A graphical User interface system supporting a medical record comprising:
a menu generator for generating:
at least one menu permitting User browsing of at least one folder of a medical record; and
a menu permitting User entries to the medical record, wherein each entry is automatically filed into at least one desired folder of the medical record.

21. The graphical User interface of claim 20, further comprising a means for accessing a multimedia file including a portion of an entry to the medical record.

22. The graphical User interface of claim 20, wherein the multimedia file is comprised of multipurpose Internet mail extensions.
